(19) United States
(12) Patent Application Publication
(10) Pub. No.: US 2024/0253063 A1
(43) Pub. Date: Aug. 1, 2024

(54) A CENTRIFUGAL SEPARATOR

(71) Applicant: ALFA LAVAL CORPORATE AB, LUND (SE)

(72) Inventors: Kasper HÖGLUND, RÖNNINGE (SE); Thomas ELIASSON, ÄLVSJÖ (SE)

(73) Assignee: ALFA LAVAL CORPORATE AB, LUND (SE)

(21) Appl. No.: 18/290,520

(22) PCT Filed: May 6, 2022
(86) PCT No.: PCT/EP2022/062294

§ 371 Date: Nov. 14, 2023

(30) Foreign Application Priority Data
May 28, 2021 (EP) 21176714.0

(51) Int. Cl. B04B 15/02; B04B 9/04

(52) U.S. Cl. CPC B04B 15/02; B04B 9/04

(57) ABSTRACT

A centrifugal separator for separating a fluid mixture into a first component and a second component, wherein the second component is denser than the first component, includes a rotating bowl, which is rotatably supported by a frame around a rotational drive shaft, and which rotational drive shaft is rotatable around an axis of rotation; an electrical motor connected to the rotational drive shaft; an inlet to the rotating bowl; a first outlet for the separated lighter first component of the fluid mixture; and a second outlet for the separated second component of the fluid mixture; and a cooling device including a body connected to the frame, wherein the body includes a central opening provided with an inner peripheral surface, which is connected to a stator of the electrical motor; and wherein the body further includes an outer peripheral surface; and a cooling coil arranged in the body and extending circumferentially around the central opening, wherein the cooling coil includes a tube provided with an inlet opening and an outlet opening for a cooling fluid.

### TECHNICAL FIELD

The present disclosure relates to a centrifugal separator.

### BACKGROUND ART

Centrifugal separators are generally used for separation of liquids and/or solids from a liquid mixture or a gas mixture. During operation, fluid mixture that is about to be separated is introduced into a rotating separator bowl and due to the centrifugal forces, heavy particles or denser liquid, such as water, accumulates at the periphery of the rotating bowl whereas less dense liquid accumulates closer to the centre axis of rotation. This allows for collection of the separated fractions, e.g. by means of different outlets arranged at the periphery and close to the rotational axis, respectively. Separation discs are stacked in the rotating bowl at a mutual distance to form interspaces between themselves, thus forming surface-enlarging inserts within the bowl.

The rotational movement of the separator bowl is generated by an electrical motor, which is provided with a rotor and a stator. In order to avoid overheating and damage to the electrical motor, a cooling element may be provided as a means for cooling the electrical motor.

There are known centrifugal separators, which are provided with a cooling coil moulded in a frame of the centrifugal separator. The cooling coil is arranged adjacent to the electrical motor, so that cooling fluid in the cooling coil can absorb heat from the electrical motor in order to conduct heat away from the electrical motor.

### SUMMARY OF THE INVENTION

The known centrifugal separators provided with cooling devices for electrical motors are complicated to manufacture and assemble, comprise time consuming maintenance and only use a fraction of available cooling potential of the cooling device.

There is thus a need for an improved centrifugal separator, provided with a cooling device for a motor, which is uncomplicated to manufacture and assemble, which is easy to maintenance and in which most of the available cooling potential is used.

An objective of the invention is thus to provide an improved centrifugal separator, provided with a cooling device for an electrical motor, which is uncomplicated to manufacture and assemble, which is easy to maintenance and in which most of the available cooling potential is used.

These objectives are achieved by a centrifugal separator according to the appended claims.

According to an aspect of the invention, a centrifugal separator for separating a fluid mixture into a first component and a second component is provided, wherein the second component is denser than the first component. The centrifugal separator comprises: a rotating bowl, which is rotatably supported by a frame around a rotational drive shaft, and which rotational drive shaft is rotatable around an axis of rotation; an electrical motor connected to the rotational drive shaft; an inlet to the rotating bowl; a first outlet for the separated lighter first component of the fluid mixture; and a second outlet for the separated second component of the fluid mixture; a cooling device for the electrical motor comprising: a body connected to the frame of the centrifugal separator, wherein the body comprises a central opening provided with an inner peripheral surface, which is connected to a stator of the electrical motor; and wherein the body further comprising an outer peripheral surface; and a cooling coil arranged in the body and extending circumferentially around the central opening, wherein the cooling coil comprises a tube provided with an inlet opening and an outlet opening for a cooling fluid.

The body of the cooling device and the frame of the centrifugal separator may be two separate parts, which are connected to each other. Thus, the cooling device can be manufactured as a single component separated from the frame. This will simplify the manufacturing of both the centrifugal separator and the cooling device. Since the body of the cooling device only needs to take reaction forces from torque generated by the electrical motor, the connection between the body and the frame can be of any type. Thus, the connection between the body of the cooling device and the frame of the centrifugal separator can be made simple, which may simplify the assembling and disassembling of the body to and from the frame. The connection between the inner peripheral surface of the body and the stator of the motor may adapted for the facilitation of heat transfer from the stator to the body. The cooling coil may extend a turn or a number of turns in the body and circumferentially around the central opening. The cooling fluid may be any type of fluid that effectively promotes heat dissipation from the body. An example of a cooling fluid is water.

Further objects, advantages and novel features of the present invention will become apparent to one skilled in the art from the following details, and also by putting the invention into practice. Whereas embodiments of the invention are described below, it should be noted that it is not restricted to the specific details described. Specialists having access to the teachings herein will recognise further applications, modifications and incorporations within other fields, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various figures, and in which:

FIG. 1 illustrates a schematic section view of a centrifugal separator according to an example;

FIG. 2a illustrates a schematic section view of a cooling device according to an example;

FIG. 2b illustrates a schematic view from above of a cooling device according to an example;

FIG. 3 illustrates a schematic view in perspective of a cooling coil according to an example;

FIG. 4 illustrates a schematic section view of a lower portion of a centrifugal separator according to an example; and

FIG. 5 illustrates a schematic exploded view of a centrifugal separator according to an example.

### DETAILED DESCRIPTION

The detailed description with reference to the examples depicted are to be viewed as examples comprising a combination of certain features, which features have been described in detail above. It is thus to be understood that additional examples may be achieved by combining other features into examples not depicted herein. The figures are to be viewed as examples and not mutually exclusive combinations. It should also be noted that all figures shown and described are schematically represented, wherein generic parts of machinery or similar is not depicted for the sake of simplicity.

According to an aspect of the present disclosure a centrifugal separator for separating a fluid mixture into a first component and a second component is provided, wherein the second component is denser than the first component. The centrifugal separator comprises: a rotating bowl, which is rotatably supported by a frame around a rotational drive shaft, and which rotational drive shaft is rotatable around an axis of rotation; an electrical motor connected to the rotational drive shaft; an inlet to the rotating bowl; a first outlet for the separated lighter first component of the fluid mixture; and a second outlet for the separated second component of the fluid mixture; a cooling device for the electrical motor comprising: a body connected to the frame of the centrifugal separator, wherein the body comprises a central opening provided with an inner peripheral surface, which is connected to a stator of the electrical motor; and wherein the body further comprising an outer peripheral surface; and a cooling coil arranged in the body and extending circumferentially around the central opening, wherein the cooling coil comprises a tube provided with an inlet opening and an outlet opening for a cooling fluid.

Centrifugal separators may be used for separation of liquids and/or solids from fluid mixture, such as a liquid mixture or a gas mixture. During operation, fluid mixture that is about to be separated into components is introduced into a rotating bowl, and due to the centrifugal forces, a heavy component accumulates at the periphery of the rotating bowl whereas less dense component accumulates closer to the centre axis of rotation. This allows for collection of the separated components, e.g. by means of different outlets arranged at the periphery and close to the rotational axis, respectively. Separation discs are stacked in the rotating bowl at a mutual distance to form interspaces between themselves, thus forming surface-enlarging inserts within the bowl. During operation, substances moves outwards in the interspaces between discs in the stack of separation discs used in the centrifugal separator, whereas one component of the substance, having a lower density than another component of the substance moves radially inwards towards the axis of rotation. Both components may thus be collected via the different outlets. The first outlet may be arranged close to the axis of rotation. The second outlet may be arranged at the periphery of the rotating bowl. The separator may also comprise at third outlet arranged close to the axis of rotation. The number of outlets depends on the number of components to be separated from the fluid mixture. The fluid mixture may comprise any kind substances or components such as substances or components used in the industry. The fluid mixture may comprise a number of different components.

The rotating bowl is rotatably supported by the frame. The rotational drive shaft is at one end connected to the rotating bowl and is further connected to an electrical motor. Thus, the drive shaft transmits torque and rotational movement from the electrical motor to the rotating bowl.

The rotational drive shaft may be a hollow shaft for introducing liquid feed mixture to be separated to the inlet to the rotating bowl. Thus the fluid mixture may be introduced to the rotational bowl through a central cavity of the rotational drive shaft. The central cavity may thus form a central bore, which extends in the longitudinal direction of the drive shaft. As an alternative, the rotational drive shaft may be a hollow shaft through which one of the separated phases is discharged, i.e. the central cavity or bore may be connected to an outlet of the rotor. According to a further alternative, the rotational drive shaft may be a homogeneous shaft without a central cavity. The inlet for the fluid mixture and the outlets for the separated components may be arranged at the top of the rotating bowl and/or on the periphery of the rotating bowl. The inlet may then be in the form of a stationary inlet pipe extending into the rotating bowl from the top.

The body of the cooling device and the frame of the centrifugal separator are two separate parts, which are connected to each other. Thus, the cooling device can be manufactured as a single component separated from the frame. This will simplify the manufacturing of both the centrifugal separator and the cooling device. The body of the cooling device has a central opening with an inner peripheral surface. During operation of the electrical motor, heat is generated in the stator. The heat is conducted away from the stator to the body of the cooling device through the connection between the stator and the body of the cooling device. An outer surface of the stator may be connected to the inner peripheral surface of the body. The central opening of the body may have an inner diameter, which is larger than the outer radial dimensions of the stator. The body may at least partly accommodate the stator.

Since the body of the cooling device only needs to take reaction forces from torque generated by the electrical motor, the connection between the body and the frame can be of any suitable type. The stator may be press-fitted against the inner peripheral surface of the body. Alternatively, the stator may be connected to the body by fastening elements. The connection between the inner peripheral surface of the body and the stator of the motor should be adapted for the facilitation of heat transfer from the stator to the body. The connection between the body of the cooling device and the frame of the centrifugal separator can be made simple, which may simplify the assembling and disassembling of the body to and from the frame. The outer peripheral surface of the body may be configured to conduct heat to the surroundings.

The cooling coil may extend a turn or a number of turns in the body and circumferentially around the central opening. The cooling fluid may be any type of fluid that effectively promotes heat dissipation from the body. An example of a cooling fluid is water. The cooling coil may be a tube with a tubular cross section. The cooling fluid may enter the cooling coil through the inlet opening. Heat from the body may be conducted to the cooling fluid. The cooling fluid flows in the cooling coil. The fluid flow is generated by a fluid pump. The cooling fluid may exit the cooling coil through the outlet opening. According to an example the hot cooling fluid, which exits the outlet opening may be transferred to a cooler, such as a heat exchanger, and thereafter returned to the cooling coil in the body. Thus, the cooling coil may be a part of a closed loop, comprising a cooler and a fluid pump.

According to an aspect, a first end part and a second end part of the tube are configured to extend axially in the separator, wherein the inlet opening is arranged in the first end part and the outlet opening is arranged in the second end part. The axial extension of the first and second end parts may facilitate the assembling and disassembling of the body to and from the frame. The stator may first be connected to the body of the cooling device. Thereafter, the body and the stator are brought together into the frame of the centrifugal separator in the direction of the axial extension of the drive shaft. The first and second end parts of the tube may during the axial displacement of the body and the stator be brought into an axially extending aperture or apertures in the frame of the separator, which is possible due to the axial extension of the first end part and a second end part of the tube.

According to an aspect, the body comprises a first axially directed end surface and a second axially directed end surface, and wherein the first end part and the second end part of the tube are configured to extend through the first axially directed end surface. This configuration results on a compact body of the cooling device. The radial extension of the body may be limited to diameter of the tube. The first and second axially directed end surfaces each have a normal, which is directed in parallel to the axis of rotation of the rotational drive shaft. The normal of the first axially directed end surface is directed downwards. The normal of the second axially directed end surface is directed upwards, towards the rotating bowl.

According to an aspect, the first axially directed end surface of the body comprises a sleeve, which is configured to be received in a circular groove arranged in the frame of the centrifugal separator. The sleeve may extend circumferential on the first axially directed end surface. The circular groove arranged in the frame may be adapted to an inner diameter and an outer diameter of the sleeve, so that the sleeve can be moved axially into the groove during assembling of the cooling device in the frame. The circular groove may be configured to fixate the cooling device in the frame.

According to an aspect, the first end part and the second end part of the tube are configured to extend through the sleeve. This configuration results in a compact body of the cooling device. Further, an axial extension of the first and second end parts may facilitate the assembling and disassembling of the body to and from the frame as mentioned above. After assembling, the first and second end parts extend through apertures in the bottom of the circular groove arranged in the frame.

According to an aspect, the tube comprises a material with higher corrosion resistivity than the material of the body. This configuration allows for a selection of materials of the body, which are not corrosion resistant to the cooling fluid. As an example, the cooling coil may be of steel, such as stainless steel. As an example, the body may be of aluminium and the cooling coil of stainless steel.

As an example, the body of the cooling device may be of, or comprise, a metal having a high thermal conductivity, such as aluminium. As an example, the body of the cooling device may consist of, or comprise, a metal having a thermal conductivity that is above 80, such as above 100, such as above 150 W·m⁻¹·K⁻¹. Such thermal conductivity allows for efficient cooling via the cooling coil. Thus, the body of the cooling device may be of, or comprise, a metal having a thermal conductivity that is higher than the thermal conductivity of iron, which may be around 80 W·m⁻¹·K⁻¹.

The body of the cooling device may be a one-piece metal part, for example a die-cast part made of light metal, such as aluminium or magnesium. These materials also have good heat conductivity.

The stator may be press-fitted against the inner peripheral surface of the body. The body of the cooling device may consist of, or comprise, a metal having a melting temperature below 1000° C., such as below 800° ° C. This may allow for press-fitting the stator into the body at relatively low temperatures.

According to an aspect, the body has an axial length extension similar to the axial length extension of the stator. The stator may comprise a number of steel plates through which windings are arranged. The windings may have an axial length extension, which is larger than the axial length extension of the steel plates. Thus, the body having an axial length extension similar to the axial length extension of the stator may promote heat dissipation from the entire length of the stator and not only from the steel plates.

According to an aspect, the body comprises cooling fins. A number of cooling fins may extend radially from the outer peripheral surface of the body. Heat generated in the stator may be conducted to air surrounding the stator. The heated air is configured to flow between the cooling fins. Heat in the air is conducted to the cooling fins and further to the body of the cooling device. Heat in the body is conducted to the cooling fluid in the cooling coil. The heated cooling fluid is led away by the fluid flow in the cooling coil and out of the cooling coil through the outlet opening of the tube.

According to an aspect, the cooling fins extend axially from the first axially directed end surface to the second axially directed end surface of the body. The cooling fins may extend axially on outer peripheral surface of the body. This way, a large surface of the cooling fins is achieved. The large surface may increase the effect of heat in the air to be conducted to the cooling fins and further to the body of the cooling device.

According to an aspect, the shape of the body is configured to provide an air gap between the outer peripheral surface of the body and the frame of the centrifugal separator. The air gap allows air to pass the outer peripheral surface of the body. Heat in the air may be conducted to the outer peripheral surface of the body and further to the cooling fluid in the cooling coil. The heated cooling fluid is led away by the fluid flow in the cooling coil and out of the cooling coil through the outlet opening of the tube. In case the body comprises cooling fins, the fins may be housed within the gap. Alternatively, the gap may be arranged radially outside the fins.

According to an aspect, the outer peripheral surface of the body comprises a circumferentially and radially extending rim, configured to be connected to the frame of the centrifugal separator. The rim prevents air to flow from one end surface of the body to the other end surface of the body. This way, possible fire that has been developed in the electrical motor may not be spread from one end surface of the body to the other end surface of the body along the outside of the body.

According to an aspect, the rim is arranged on the outer peripheral surface at an axial position between a first axially directed end surface and a second axially directed end surface of the body. This way, air and possible fire are prevented to flow and to be spread from one end surface of the body to the other end surface of the body. In addition, the rim may provide a support for the body in relation to the frame of the centrifugal separator. The rim may stabilize the body in the radial direction.

According to an aspect, the cooling device is a housing for the stator. The outer surface of the stator may be connected to the inner peripheral surface of the body. This way, the body is a support for the stator. The central opening of the body may be configured to at least partly accommodate the stator and thus the cooling device may be a housing for the stator. Thus, the housing is a support for the stator, such as a support within the frame. Further, the housing may enclose the stator, at least partially. This way, the body of the cooling device fixates the position of the stator both axially and radially.

According to an aspect, a rotor of the electrical motor is arranged on the rotational drive shaft, so that a centre axis of the electrical motor coincides with axis of rotation. The rotational drive shaft is at one end connected to the rotating bowl and is further connected to the electrical motor. The rotor of the electrical motor is arranged on the rotational drive shaft. The rotational drive shaft may pass through the rotor of the electrical motor. The rotor is configured to rotate together with the rotational drive shaft. The rotor may be fixed to the rotational drive shaft and thus rotate with the same rotational speed as the rotational drive shaft. The rotor may be provided with wings, which may bring the air surrounding the rotor, stator and the cooling device to circulate.

The present disclosure will now be further illustrated with reference to the appended figures.

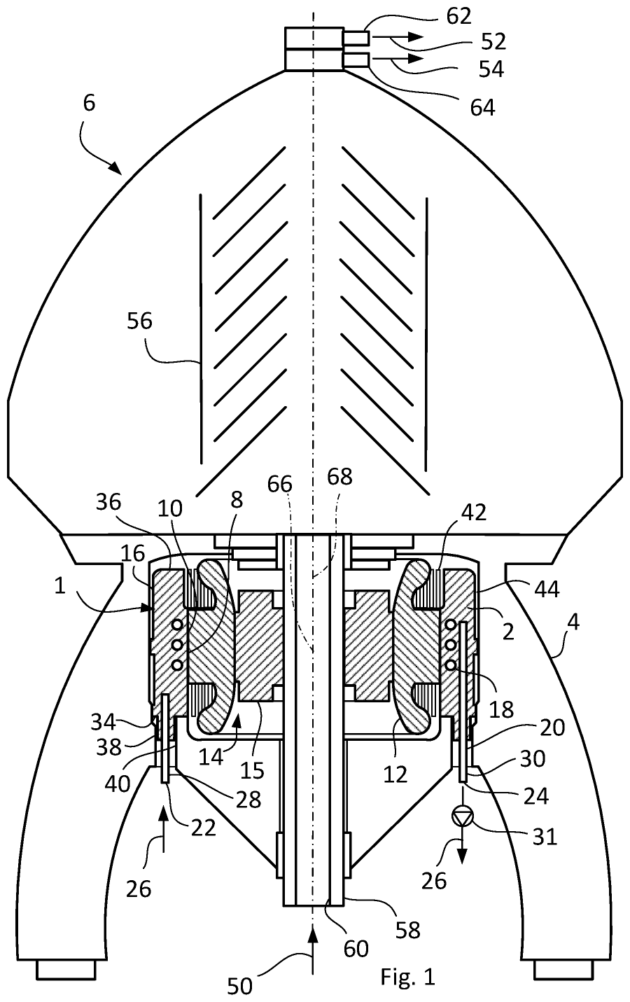

FIG. 1 illustrates a schematic section view of a centrifugal separator according to an example. The centrifugal separator 6 is provided with a cooling device 1. The cooling device 1 comprises a body 2, which is configured to be connected to the frame 4 of the centrifugal separator 6. The body 2 comprises a central opening 8 provided with an inner peripheral surface 10, which is configured to be connected to a stator 12 of an electrical motor 14. The cooling device is a housing for the stator 12. The body 2 has an axial length extension similar to the axial length extension of the stator 12. The electrical motor 14 comprises a rotor 15. The body 2 further comprises an outer peripheral surface 16. A cooling coil 18 is arranged in the body 2. The cooling coil 18 is configured to extend circumferentially around the central opening 8 of the body. The cooling coil 18 comprises a tube 20, which is provided with an inlet opening 22 and an outlet opening 24 for a cooling fluid 26. A first end part 28 and a second end part 30 of the tube 20 are configured to extend axially in the separator 6. The inlet opening 22 is arranged in the first end part 28 and the outlet opening 24 is arranged in the second end part 30. A cooling fluid pump 31 is configured to generate a flow of the cooling fluid 26 in the cooling coil 18.

The body 2 comprises a first axially directed end surface 34 and a second axially directed end surface 36. The first end part 28 and the second end part 30 of the tube 20 are configured to extend through the first axially directed end surface 34. The first axially directed end surface 34 of the body 2 comprises a sleeve 38, which is configured to be received in a circular groove 40 arranged in the frame 4 of the centrifugal separator 6. The first end part 28 and the second end part 30 of the tube 20 are configured to extend through the sleeve 38 and further through the groove 40 and out of the frame 4.

The centrifugal separator 6 is configured for separating a fluid mixture 50 into a first component 52 and a second component 54. The second component 54 is in this example denser than the first component 52. The centrifugal separator 6 comprising a rotating bowl 56, which is rotatably supported by the frame 4 around a rotational drive shaft 58. The rotational drive shaft 58 is rotatable around an axis of rotation 68. An electrical motor 14 is connected to the rotational drive shaft 58. An inlet 60 for the fluid mixture 50 is arranged to the rotating bowl 56. A first outlet 62 is arranged for the separated lighter first component 52 of the fluid mixture 50. A second outlet 64 for the separated second component 54 of the fluid mixture 50. The rotor 15 of the electrical motor 14 is arranged on the rotational drive shaft 58, so that a centre axis 66 of the electrical motor 14 coincides with the axis of rotation 68.

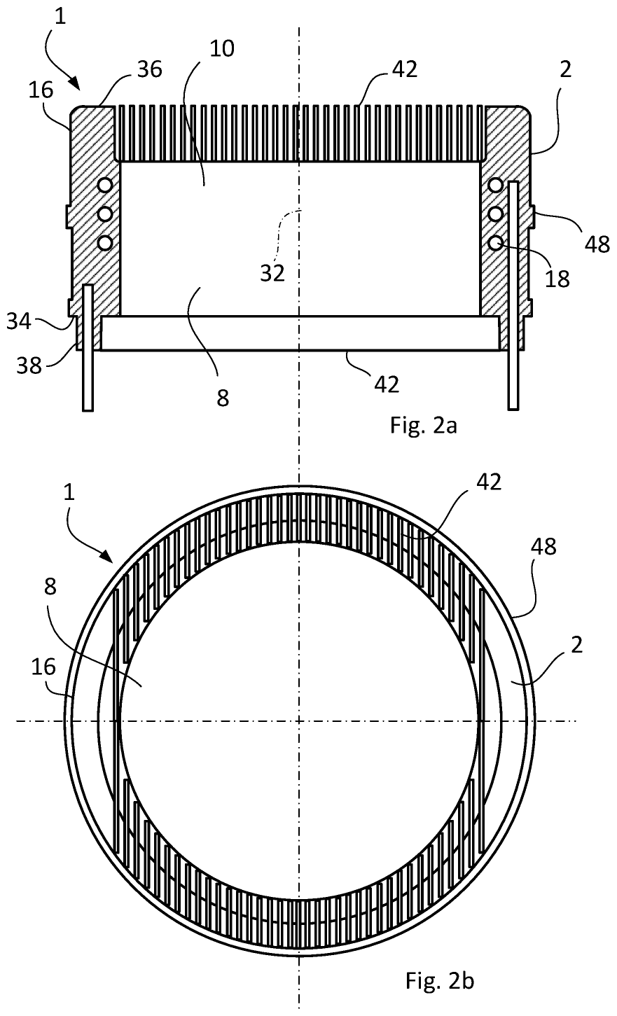

FIGS. 2a and 2b illustrate a cooling device 1 according to an example. FIG. 2a is a section view and FIG. 2b is a view from above. The body 2 comprises a number of cooling fins 42, which extend radially from the outer peripheral surface 16 of the body 2. In addition, a number of cooling fins 42 may extend axially from the first and second axially directed end surface 34, 36 of the body 2. The outer peripheral surface 16 of the body 2 comprises a circumferentially and radially extending rim 48, which is configured to be connected to the frame 4 of the centrifugal separator 6 (FIG. 1). The rim 48 is arranged on the outer peripheral surface 16 at an axial position between the first axially directed end surface 34 and the second axially directed end surface 36 of the body 2. The cooling coil 18 extends in a number of turns in the body 2. The sleeve 38 extends from the first axially directed end surface 34. A centre axis 32 of the body 2 of the cooling device 1 extends axially through the central opening 8 of the body 2. The central opening 8 of the body 2 is provided with the inner peripheral surface 10.

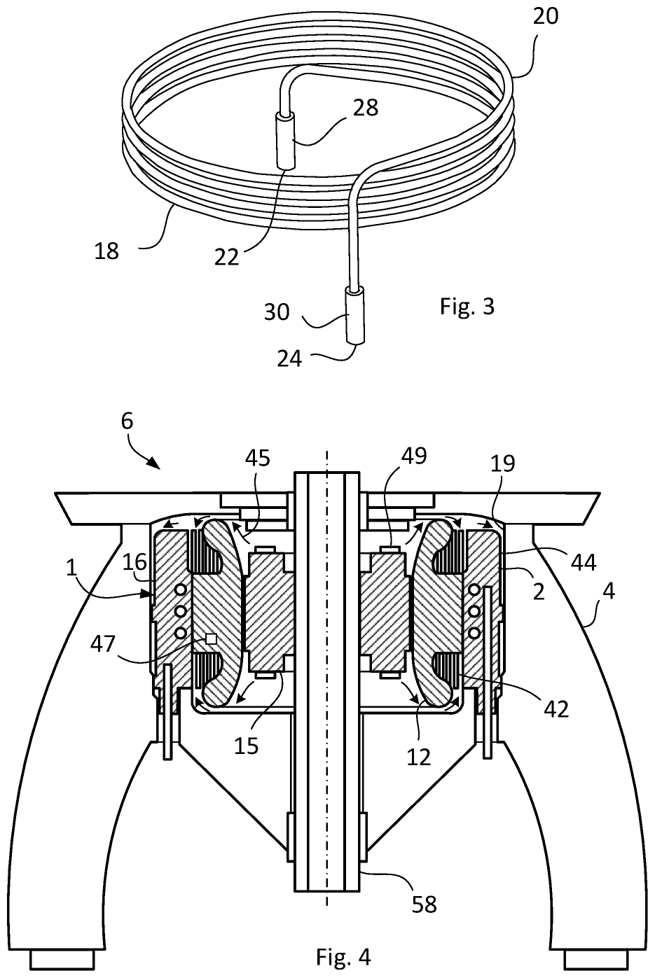

FIG. 3 illustrates a schematic view in perspective of a cooling coil 18 according to an example. The cooling coil 18 extends in a number of turns. The cooling coil 18 is a tube 20 with a tubular cross section. The first end part 28 and a second end part 30 of the tube 20 are configured to extend axially in relation to the turns of the tube 20. The inlet opening 22 is arranged in the first end part 28 and the outlet opening 24 is arranged in the second end part 30. The tube 20 comprises a material with higher corrosion resistivity than the material of the body 2. An example of material in the tube 20 is stainless steel.

FIG. 4 illustrates a schematic section view of a lower portion of a centrifugal separator 6 according to an example. The shape of the body 2 is configured to provide an air gap 44 between the outer peripheral surface 16 of the body 2 and the frame 4 of the centrifugal separator 6. The air gap 44 allows air to pass the outer peripheral surface 16 of the body 2, which is illustrated with arrows 45 in FIG. 4. The air gap 44 may be arranged radially outside the cooling fins 42. A temperature sensor 47 may be arranged in the stator 12. Wings 49 arranged on the rotor 15 are configured to generate an air flow within a cavity 19 in the frame 4. The rotor 15 provided with the wings 49, bring the air surrounding the rotor, stator and the cooling device to circulate.

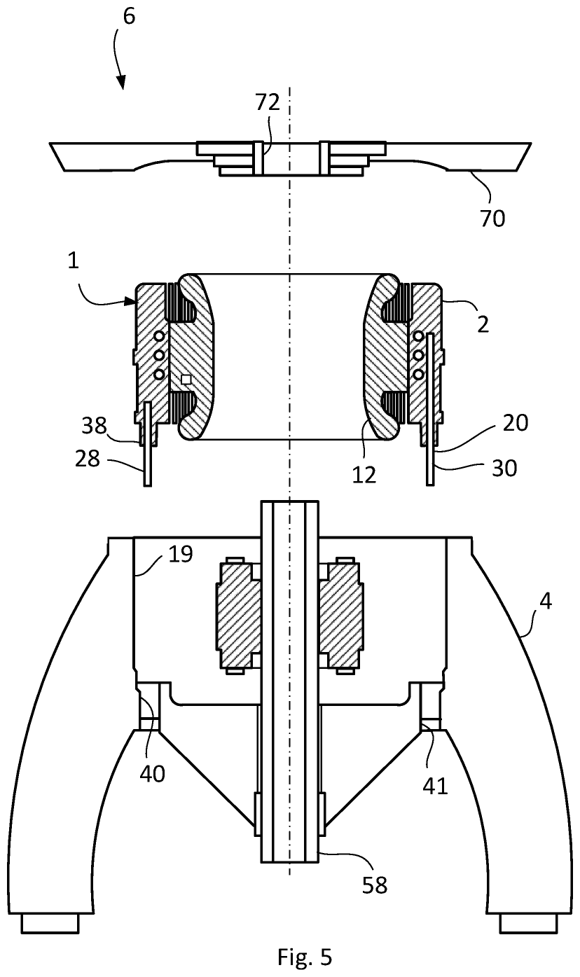

FIG. 5 illustrates a schematic exploded view of a centrifugal separator 6 according to an example. The axial extension of the first and second end parts 28, 30 of the tube 20 may facilitate the assembling and disassembling of the body 2 to and from the frame. In FIG. 5 the stator 12 has been connected to the body 2 of the cooling device 1. Thereafter, the body 2 and the stator 12 are brought together into the cavity 19 of the frame 4 of the centrifugal separator 6 in the direction of the axial extension of the drive shaft 58. The first and second end parts 28, 30 of the tube 20 are during the axial displacement of the body 2 and the cooling device 1 brought into the circular groove 40 and axially extending apertures 41 in the frame 4 of the separator 6. The circular groove 40 arranged in the frame 4 is adapted to the inner and outer diameter of the sleeve, so that the sleeve 38 can be moved axially into the groove 40 during assembling of the cooling device 1 in the frame 4. After the assembling of the cooling device 1 and the stator 12, a lid 70 of the centrifugal separator 6 is arranged on the frame 4. The lid 70 covers the cavity 19 in the frame 4 and the lid 70 also comprises a bearing 72 for the drive shaft 58. Finally, the rotating bowl 56 (FIG. 1) of the centrifugal separator 6 is installed on the rotational drive shaft 58.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the arts to understand the invention in terms of its various embodiments and with the various modifications that are applicable to its intended use. The components and features specified above may, within the framework of the disclosure, be combined between different embodiments specified.

1. A centrifugal separator for separating a fluid mixture into a first component and a second component, wherein the second component is denser than the first component, said centrifugal separator comprising:
a rotating bowl, the rotating bowl being rotatably supported by a frame around a rotational drive shaft, the rotational drive shaft being rotatable around an axis of rotation;
an electrical motor connected to the rotational drive shaft;
an inlet to the rotating bowl;
a first outlet for the separated lighter first component of the fluid mixture; and
a second outlet for the separated denser second component of the fluid mixture; and
a cooling device for the electrical motor comprising:
a body connected to the frame, wherein the body comprises a central opening provided with an inner peripheral surface, the inner peripheral surface being connected to a stator of the electrical motor, and wherein the body further comprises an outer peripheral surface; and
a cooling coil arranged in the body and extending circumferentially around the central opening, wherein the cooling coil comprises a tube provided with an inlet opening and an outlet opening for a cooling fluid.

2. The separator according to claim 1, wherein a first end part and a second end part of the tube are configured to extend axially in the separator, wherein the inlet opening is arranged in the first end part and the outlet opening is arranged in the second end part.

3. The separator according to claim 2, wherein the body comprises a first axially directed end surface and a second axially directed end surface, and wherein the first end part and the second end part of the tube are configured to extend through the first axially directed end surface.

4. The separator according to claim 3, wherein the first axially directed end surface of the body comprises a sleeve, the sleeve being configured to be received in a circular groove arranged in the frame.

5. The separator according to claim 4, wherein the first end part and the second end part of the tube are configured to extend through the sleeve.

6. The separator according to claim 1, wherein the tube comprises a material with higher corrosion resistivity than a material of the body.

7. The separator according to claim 1, wherein the body has an axial length extension similar to an axial length extension of the stator.

8. The separator according to claim 1, wherein the body comprises cooling fins.

9. The separator according to claim 8, wherein the cooling fins extend axially from a first axially directed end surface to a second axially directed end surface of the body.

10. The separator according to claim 1, wherein a shape of the body is configured to provide an air gap between the outer peripheral surface of the body and the frame.

11. The separator according to claim 1, wherein the outer peripheral surface of the body comprises a circumferentially and radially extending rim, the rim being configured to be connected to the frame.

12. The separator according to claim 11, wherein the rim is arranged on the outer peripheral surface at an axial position between a first axially directed end surface and a second axially directed end surface of the body.

13. The separator according to claim 1, wherein the cooling device is a housing for the stator.

14. The separator according to claim 1, wherein a rotor of the electrical motor is arranged on the rotational drive shaft, so that a centre axis of the electrical motor coincides with the axis of rotation.

15. The separator according to claim 1, wherein the body of the cooling device consists of, or comprises, a metal having a thermal conductivity that is above 100 W·m⁻¹·K⁻¹.

16. The separator according to claim 2, wherein the tube comprises a material with higher corrosion resistivity than a material of the body.

17. The separator according to claim 3, wherein the tube comprises a material with higher corrosion resistivity than a material of the body.

18. The separator according to claim 4, wherein the tube comprises a material with higher corrosion resistivity than a material of the body.

19. The separator according to claim 5, wherein the tube comprises a material with higher corrosion resistivity than a material of the body.

20. The separator according to claim 2, wherein the body has an axial length extension similar to an axial length extension of the stator.
